(19) United States
(12) Patent Application Publication
(10) Pub. No.: US 2015/0373472 A1
(43) Pub. Date: Dec. 24, 2015

(54) DATA PROCESSING DEVICE AND DATA PROCESSING PROGRAM

(71) Applicant: NIKON CORPORATION, Tokyo (JP)

(72) Inventors: Kei KITANI, Atsugi (JP); Takeshi YAGI, Tokyo (JP)

(73) Assignee: NIKON CORPORATION, Tokyo (JP)

(21) Appl. No.: 14/745,876

(22) Filed: Jun. 22, 2015

Related U.S. Application Data
(63) Continuation of application No. PCT/JP2013/084468, filed on Dec. 24, 2013.

(30) Foreign Application Priority Data
Dec. 28, 2012 (JP) 2012-286616

(51) Int. Cl. H04S 3/00

(52) U.S. Cl. CPC H04S 3/008; H04S 2400/11

(57) ABSTRACT

A data processing device includes a conversion processing unit configured to convert first vibration data into second vibration data configured to control localization of a vibration through a vibration state of a vibration unit included in an application device, on the basis of configuration information indicating a configuration of the vibration unit and the first vibration data which is input.

### CROSS-REFERENCE TO RELATED APPLICATION

Priority is claimed on Japanese Patent Application No. 2012-286616, filed on Dec. 28, 2012. This application is a continuation application of International Patent Application No. PCT/JP2013/084468, filed on Dec. 24, 2013. The contents of the above-mentioned application are incorporated herein by reference.

### BACKGROUND

The present invention relates to a data processing device and a data processing program.

In recent years, for example, a device that converts audio data of two channels on the right and left into audio data appropriate for a multichannel system such as a 5.1-channel surround sound system has been known (see, for example, Japanese Unexamined Patent Application, First Publication No. 2010-157861).

### SUMMARY

However, in the above-mentioned device, the format of data which is output from the device is limited to an audio data format, and data of data formats other than the audio data format may not be able to be output. That is, in the above-mentioned device, there is a problem in that the type of multichannel system which can be output to may be limited to an audio system.

An object of an aspect of the present invention is to provide a data processing device and a data processing program which are capable of expanding the types of multichannel system which can be output to.

According to an embodiment of the present invention, there is provided a data processing device including a conversion processing unit configured to convert first vibration data into second vibration data configured to control localization of a vibration through a vibration state of a vibration unit included in an application device, on the basis of configuration information indicating a configuration of the vibration unit and the first vibration data which is input.

In addition, according to an embodiment of the present invention, there is provided a data processing program configured to cause a computer to execute a conversion process step of converting first vibration data into second vibration data configured to control localization of a vibration through a vibration state of a vibration unit included in an application device, on the basis of configuration information indicating a configuration of the vibration unit and the first vibration data which is input.

According to an aspect of the present invention, it is possible to expand the types of multichannel system which can be output to.

### BRIEF DESCRIPTION OF THE DRAWINGS

FIG. 1 is a configuration diagram showing an example of a configuration of an application system according to the present embodiment.

FIG. 2 is a configuration diagram showing an example of a configuration of a conversion processing unit according to the present embodiment.

FIG. 3 is an appearance diagram showing an example of the arrangement of a vibration generation unit according to the present embodiment.

FIG. 4 is a diagram showing an example of apparent movement in which a user is able to obtain a sensation of movement in the present embodiment.

FIG. 5 is a first explanatory diagram showing a file structure of a VIB file according to the present embodiment.

FIG. 6 is a second explanatory diagram showing a file structure of the VIB file according to the present embodiment.

FIG. 7 is a third explanatory diagram showing a file structure of the VIB file according to the present embodiment.

FIG. 8 is a flow diagram showing an example of an operation of a data processing device according to the present embodiment.

FIG. 9 is a flow diagram showing an example of an operation of a file conversion process which is performed by the conversion processing unit according to the present embodiment.

FIG. 10 is a diagram showing an example of a user operation screen which is displayed on a display unit according to the present embodiment.

FIG. 11 is a flow diagram showing an example of an operation in which the data processing device according to the present embodiment reproduces a multimedia container file.

### DESCRIPTION OF EMBODIMENTS

Hereinafter, an embodiment the present invention will be described with reference to the accompanying drawings. In the following description, a performance effect obtained by a user by generating a sensation of localization, a sensation of movement and the like through the generation of a vibration is called a “vibration effect”. Here, the sensation of localization refers to a phantom sensation, that is, a “sensation felt by a user as if the localization of a vibration is present in a specific position situated between two points on the skin when the two points are vibrated (stimulated) simultaneously”. In addition, the sensation of movement refers to apparent movement, that is, a “sensation felt by a user as if the localization of a vibration moves when two points on the skin are vibrated (stimulated) with a phase difference and an output difference therebetween”.

Hereinafter, PCM (Pulse Code Modulation) data as uncompressed waveform data which is processed so as to be capable of obtaining a vibration effect is called “VPCM data”. In addition, for example, AAC (Advanced Audio Coding) data as compressed waveform data which is processed so as to be capable of obtaining a vibration effect is called “VAAC data”. Meanwhile, a tone burst may be included in these types of waveform data so as to further obtain a vibration effect.

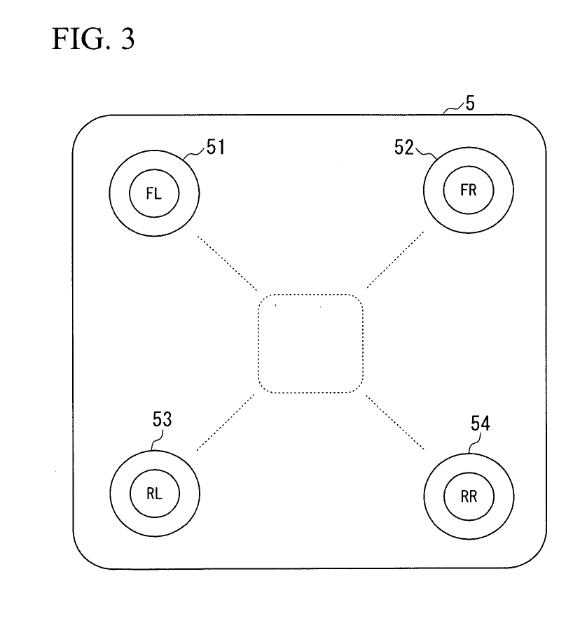

Hereinafter, data including the waveform data (for example, VPCM data or VAAC data), processed so as to be capable of obtaining a vibration effect, in accordance with a predetermined format (described later with reference to FIGS. 3 to 5) is called “vibration data (VIB data)”. Here, VIB is an abbreviation for a vibration. Hereinafter, a file including the vibration data is called a “vibration file (VIB file)”.

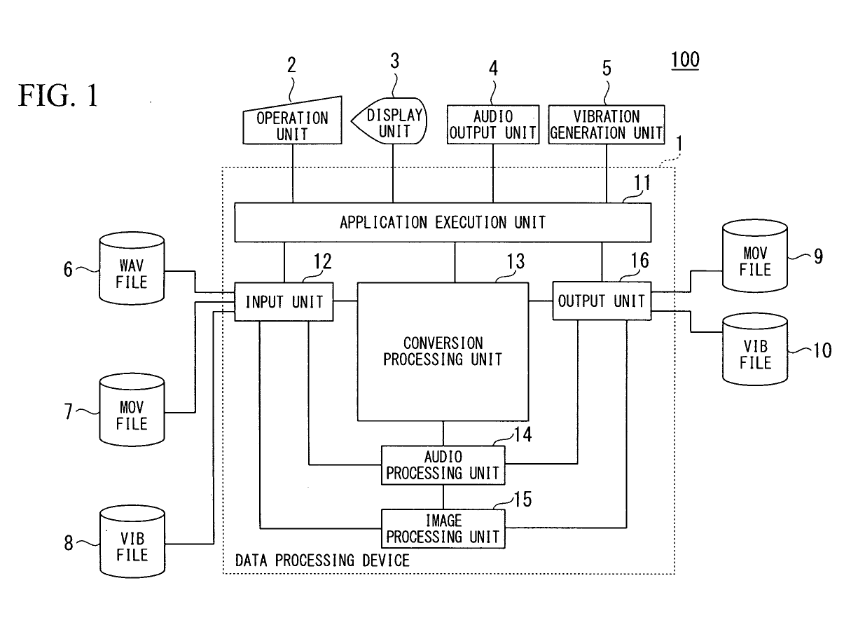

FIG. 1 is a configuration diagram showing an example of a configuration of an application system 100 according to the present embodiment. The application system 100 includes a data processing device 1, an operation unit 2, a display unit 3, an audio output unit 4, and a vibration generation unit 5. Among those, the operation unit 2 includes a keyboard, a pointing device, a controller and the like in order for a user to perform an input operation. The display unit 3 includes a display device or the like, and is configured to display an image. The audio output unit 4 includes a speaker or the like, and is configured to output audio. The vibration generation unit 5 includes vibrators, and is configured to generate a vibration in order for a user to obtain a performance effect caused by a vibration. The vibrator may be constituted by a voice coil motor (VCM), and also may be constituted by a speaker.

The data processing device 1 is configured to process vibration data, audio data, and image data. The data processing device 1 is configured to convert an input file (first vibration file) into an output file (second vibration file). Here, the input file includes a WAV file 6, a MOV file 7, and a VIB file 8. In addition, the output file includes a MOV file 9 and a VIB file 10.

The WAV file 6 refers to a file in which audio data is recorded. The WAV file 6 has audio data recorded therein through one or a plurality of channels (also referred to as ch in the following description). The MOV file 7 refers to a multimedia container file in which at least one of image data and audio data is included. The MOV file 7 has at least one of image data and audio data recorded therein through one or a plurality of channels. The VIB file 8 refers to a file in which vibration data is recorded. The VIB file 8 has vibration data recorded therein through one or a plurality of channels. The VIB file 10 refers to a file in which vibration data corresponding to the arrangement of the vibrators included in the vibration generation unit 5 is recorded. The VIB file 10 has vibration data recorded therein through channels whose number corresponding to the number of vibrators included in the vibration generation unit 5. The MOV file 9 refers to a file which is generated by the data processing device 1 by adding the vibration data (that is, vibration data corresponding to the arrangement of the vibrators included in the vibration generation unit 5) recorded in the VIB file 10 to the MOV file 7 which does not include the vibration data. The MOV file 9 has vibration data recorded therein through channels whose number corresponding to the number of vibrators included in the vibration generation unit 5.

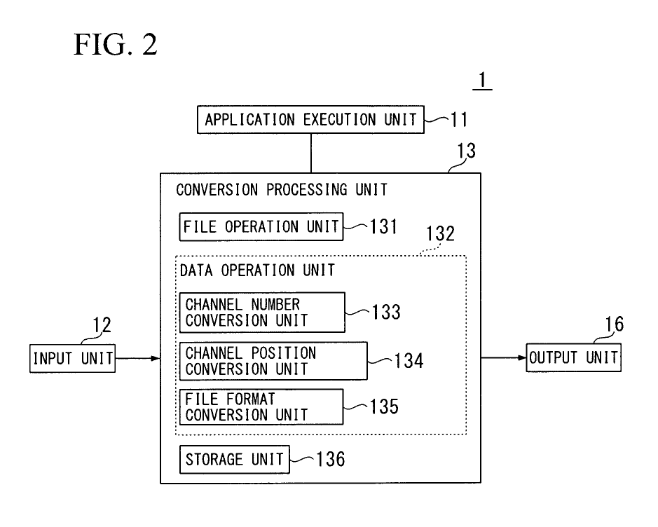

The data processing device 1 includes an application execution unit 11, an input unit 12, a conversion processing unit 13, an audio processing unit 14, an image processing unit 15, and an output unit 16. The application execution unit 11 is configured to execute an application with the WAV file 6, or the MOV file 7 and the VIB file 8 input. The input unit 12 is configured to acquire data by reading these input files. The audio processing unit 14 is configured to process the audio data among the data acquired in the input unit 12. The image processing unit 15 is configured to process the image data among the data acquired in the input unit 12. The output unit 16 is configured to write data in the MOV file 9 and the VIB file 10. The conversion processing unit 13 is configured to process the audio data and the vibration data among the data acquired in the input unit 12. A configuration of the conversion processing unit 13 will be described with reference to FIG. 2.

FIG. 2 is a configuration diagram showing an example of a configuration of the conversion processing unit 13 according to the present embodiment. The conversion processing unit 13 includes a file operation unit 131, a data operation unit 132, and a storage unit 136. Information which is used in a file conversion process is stored in the storage unit 136. For example, configuration information indicating the configuration of vibrators included in the vibration generation unit 5 is stored in the storage unit 136. Here, the configuration of the vibrators included in the vibration generation unit 5 refers to, for example, the number of vibrators included in the vibration generation unit 5, and the arrangement (coordinates or positions) of the vibrators included in the vibration generation unit 5.

The file operation unit 131 is configured to perform file manipulation on the WAV file 6, the MOV file 7, the VIB file 8, the MOV file 9, and the VIB file 10. Specifically, the file operation unit 131 reads out the audio data of the WAV file 6 and the MOV file 7 or the vibration data of the VIB file 8 through the input unit 12. In addition, the file operation unit 131 is configured to write the vibration data of the MOV file 9 or the VIB file 10 through the output unit 16. The data operation unit 132 is configured to perform data manipulation such as the conversion of the audio data and the vibration data which are read out by the file operation unit 131 into vibration data based on the configuration of the vibrators included in the vibration generation unit 5. The data operation unit 132 includes a channel number conversion unit 133, a channel position conversion unit 134, and a file format conversion unit 135.

The channel number conversion unit 133 is configured to convert the number of channels of an input file and generate an output file having the number of channels converted. Specifically, the channel number conversion unit 133 converts the number of channels of the input file on the basis of the number of channels of the input file and the configuration information indicating the number of vibrators included in the vibration generation unit 5. A structure in which the channel number conversion unit 133 converts a file will be given in detail in the description of an operation described later.

The channel position conversion unit 134 is configured to convert the localization (that is, channel position) of audio (or vibration) of each channel included in the input file and generate an output file having the converted channel position. Specifically, the channel position conversion unit 134 converts the channel position of the input file on the basis of the configuration information indicating the arrangement (coordinates or positions) of the vibrators included in the vibration generation unit 5 and localization information of each channel included in the input file. A structure in which the channel position conversion unit 134 converts files will be described later in detail in the description of an operation.

The file format conversion unit 135 is configured to convert a file of a WAV file format or a MOV file format into a file of a VIB file format. In addition, the file format conversion unit 135 is configured to convert a file of a WAV file format or a VIB file format into a file of a MOV file format.

Next, the configuration of the vibration generation unit 5 will be described. The vibration generation unit 5 includes vibrators configured to generate a vibration based on the vibration data of the output file converted by the conversion processing unit 13. The specific configuration of the vibration generation unit 5 will be described with reference to FIG. 3.

FIG. 3 is an appearance diagram showing an example of the arrangement of the vibration generation unit 5 according to the present embodiment. As an example, the vibration generation unit 5 includes a vibrator (vibration device) 51 (FL: front at the left), a vibrator 52 (FR: front at the right), a vibrator 53 (RL: rear at the left) and a vibrator 54 (RR: rear at the right), respectively, at four corners of the housing (5). The vibration generation unit 5 is configured to vibrate the housing of the vibration generation unit 5 by vibrating each of the vibrators 51 to 54 on the basis of the VPCM data or the VAAC data (that is, vibration data).

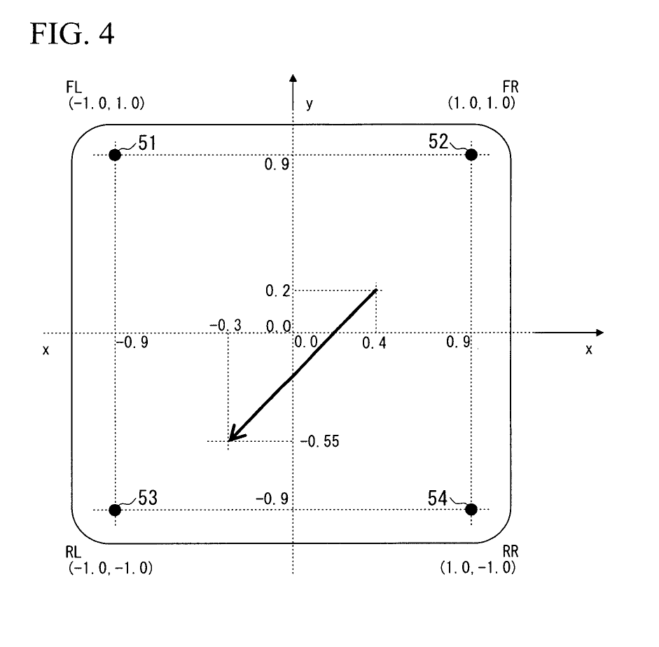

FIG. 4 is a diagram showing an example of apparent movement in which a user is able to obtain a sensation of movement. Here, for the purpose of description, a coordinate system (x, y)=(−1.0 to +1.0, −1.0 to +1.0) with the origin at the center of the housing of the vibration generation unit 5 is defined. The vibrator 51 (channel 1) is arranged at coordinates (−0.9, +0.9) as an example. In addition, the vibrator 52 (channel 2) is arranged at coordinates (+0.9, +0.9) as an example. In addition, the vibrator 53 (channel 3) is arranged at coordinates (−0.9, −0.9) as an example. In addition, the vibrator 54 (channel 4) is arranged at coordinates (+0.9, −0.9) as an example. As described above, coordinate information indicating the arrangement of these respective vibrators is stored in advance, as configuration information, in the storage unit 136 of the conversion processing unit 13.

In FIG. 4, as an example, a user can obtain such a sensation of movement as if the localization of a vibration linearly moves from start-point coordinates (+0.4, +0.2) to end-point coordinates (−0.3, −0.55). Hereinafter, when the localization of a vibration moves from the start-point coordinates to the end-point coordinates, information including the start-point coordinates and the end-point coordinates is called “vector information”. Here, the start-point coordinates and the end-point coordinates may be represented by relative coordinates. In addition, the vector information may include information indicating a vibration time (ringing time [ms]) for which the vibration unit continues a vibration.

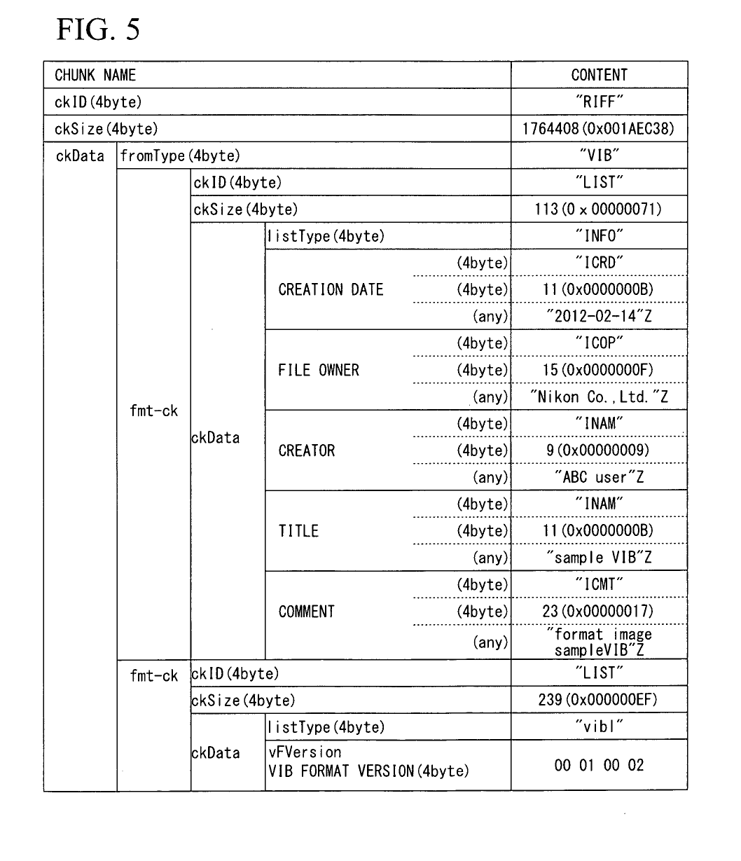

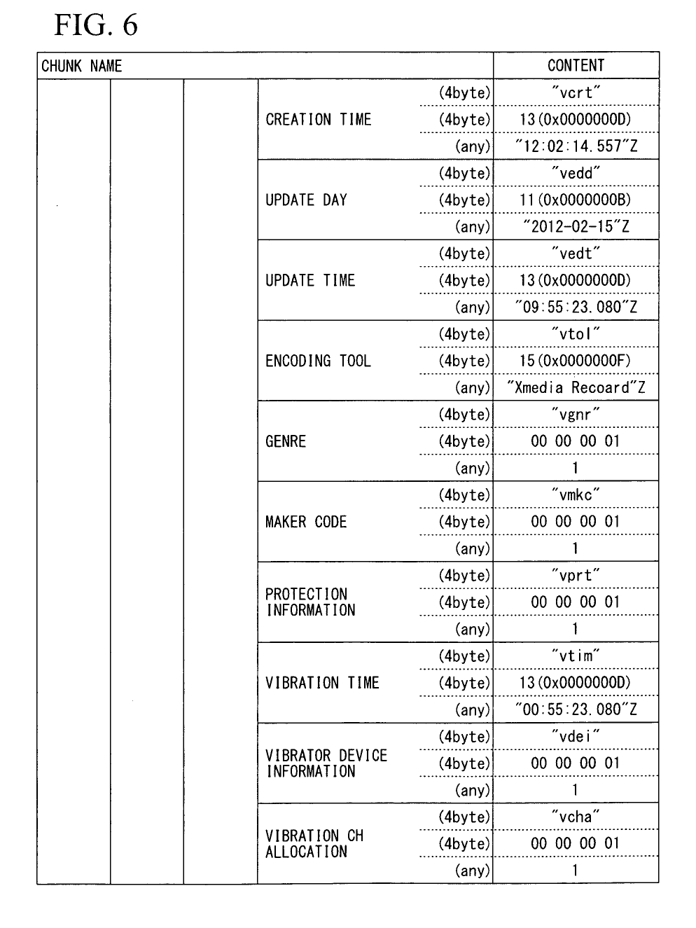

Next, the vibration file (VIB file) shown in FIG. 1 will be described with reference to FIGS. 5 to 7. FIGS. 5, 6 and 7 are diagrams showing file structures of the VIB file, respectively. Here, although the structures are shown by division into three drawings, an actual VIB file is constituted of one file. The VIB file is a file having a chunk structure. The VIB file includes information indicating list type “INFO”, information indicating the creation date, information indicating the file owner, information indicating the file creator, information indicating the title, and information indicating a comment.

In addition, the VIB file includes information indicating list type “vibl”, information indicating a version of a format of the VIB data, information indicating a creation time (creation time of instant), information indicating an update day, information indicating an update time (update time of instant), information indicating an encoding tool (such as a tool name), information indicating a genre (for example, video, audio, haptic, or game), information indicating a maker code of the VIB file, information indicating protection information (presence or absence of protection), information indicating a vibration time (reproduction time), vibrator device information (for example, identification information of a maker of the vibration unit), information indicating vibration ch (channel) allocation, information indicating a vibration frequency band (single frequency, broadband), information indicating a user comment, and GPS (Global Positioning System) information (geo-tag).

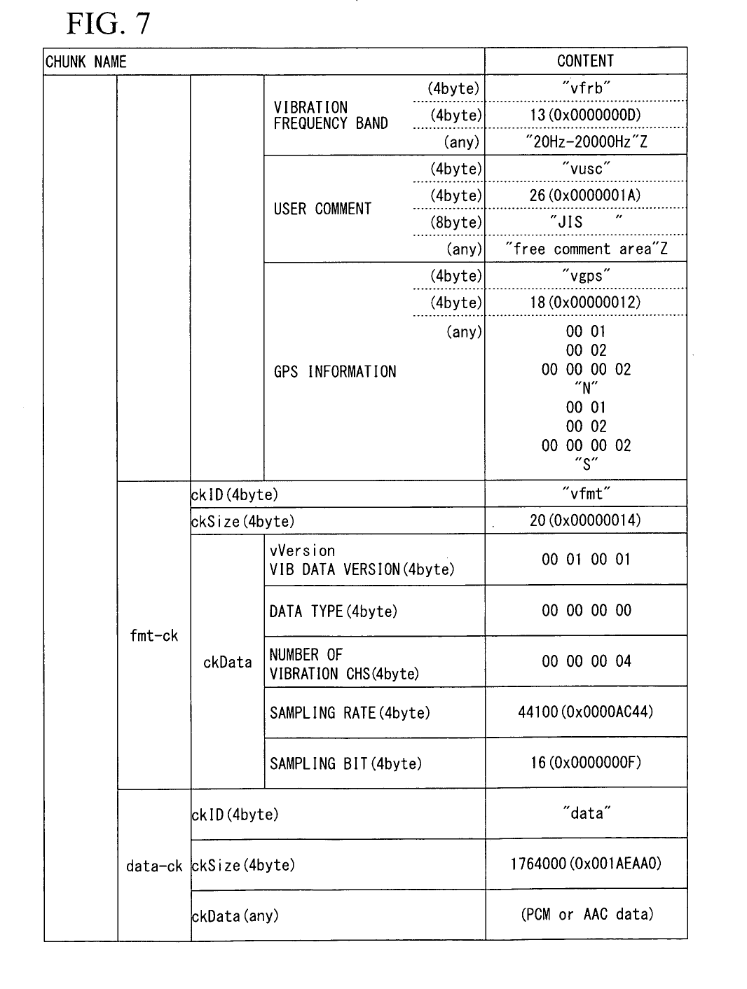

In addition, the VIB file includes information indicating a version of the VIB file (VIB data) itself, information indicating a type (for example, VPCM having a PCM format or VAAC having an AAC format) of the waveform data included in a data area (in FIG. 7, area indicated by “ckData”), information indicating the number of vibration chs (channels), information indicating a sampling rate (sampling frequency of the waveform data), and information indicating a sampling bit (quantization bit rate of the waveform data).

Hereinafter, the information indicating a creation date, the information indicating a creation time (creation time of instant), the information indicating an update day, the information indicating an update time (update time of instant), the information indicating a version of a format of the VIB data, the information indicating a version of the VIB file (VIB data) itself, the information indicating a type of the waveform data included in a data area, the information indicating the number of vibration chs (channels), the information indicating a sampling rate, the information indicating a sampling bit, the information indicating a file owner, the information indicating a file creator, the information indicating a title, the information indicating a comment, the information indicating an encoding tool, the information indicating a genre, the information indicating a maker code of the VIB file, the information indicating protection information, the information indicating a vibration time, the vibrator device information, the information indicating vibration ch (channel) allocation, the information indicating a vibration frequency band, the information indicating a user comment, and the GPS information (geo-tag) are called “VIB information” collectively.

In addition, hereinafter, the information indicating the arrangement (also called coordinates or positions) of the vibrators in the vibration generation unit 5 (see FIGS. 3 and 4), the information indicating the number of vibration chs (channels), the information indicating the sampling rate (sampling frequency of PCM data), and the information indicating the sampling bit (quantization bit rate of the PCM data) are called “configuration information” collectively. Here, the number of vibration chs (channels), the sampling rate and the sampling bit are determined on the basis of the VIB information.

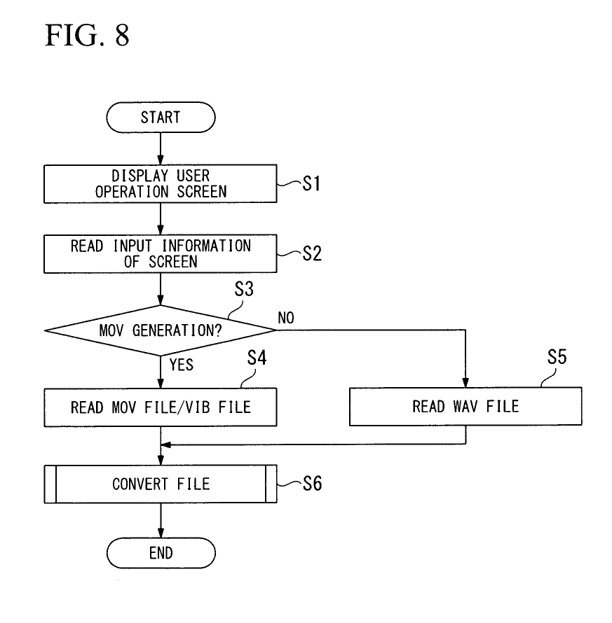

Next, an operation of the file conversion process which is performed by the data processing device 1 will be described with reference to FIG. 8.

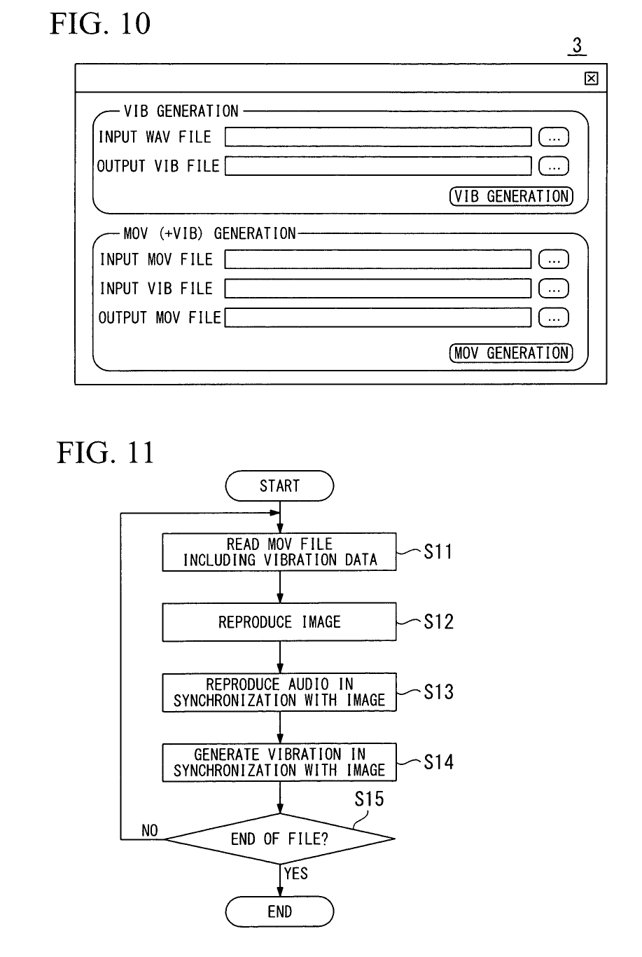

FIG. 8 is a flow diagram showing an example of an operation of the data processing device 1 according to the present embodiment. First, the application execution unit 11 displays a user operation screen on the display unit 3 (step S1). The user operation screen which is displayed on the display unit 3 refers to, for example, a screen shown in FIG. 10.

FIG. 10 is a diagram showing an example of the user operation screen which is displayed on the display unit 3 according to the present embodiment. The user operation screen includes buttons for selecting processing functions, and a user operates the operation unit 2 and selects any one of the processing functions. There are the following two functions in the selectable processing functions. A first function is a function (VIB generation function) of converting a file from the WAV file 6 to the VIB file 10. A second function is a function (MOV generation function) of extracting vibration data from the MOV file 7 and converting the extracted vibration data into the MOV file 9. This second function also includes a function of converting the vibration data of the VIB file 8 into the MOV file 9.

The user operation screen is provided with an input file name entry field into which a file name is input and an output file name entry field into which an output file name is input. When the selected processing function is the “VIB generation” function, the file name of the WAV file 6 is input to the input file name entry field as the input file name, and the file name of the VIB file 10 is input to the output file name entry field as an output file name.

On the other hand, when the selected processing function is the “MOV generation” function, the file name of the MOV file 7 is input to the input file name entry field as an input file name, and the file name of the MOV file 9 is input to the output file name entry field as an output file name.

Meanwhile, when the selected processing function is the “MOV generation” function, the file name of the VIB file 8 may be input to the input file name entry field as an input file name, instead of the file name of the MOV file 7 or together with the file name of the MOV file 7.

Referring back to FIG. 8, the description of the operation of the file conversion process which is performed by the data processing device 1 will be continued. When a user pushes a “VIB generation” button or a “MOV generation” button within the user operation screen, the application execution unit 11 reads input information (selected function and input and output file name) within the user operation screen (step S2). Here, the pushing of a button refers to, for example, clicking of a button within the user operation screen using a pointing device such as a mouse.

Next, the application execution unit 11 determines whether the selected function is the “MOV generation” function (step S3). As a result of this determination, when the selected function is the “MOV generation” function (step S3: YES), the application execution unit 11 advances the process to step S4. On the other hand, when the selected function is not the “MOV generation” function, that is, when the selected function is the “VIB generation” function (step S3: NO), the application execution unit 11 advances the process to step S5.

In step S4, the application execution unit 11 issues an instruction for the input unit 12 to read a MOV file (here, MOV file 7) specified by a MOV file name which is input to the input file name entry field. After this instruction is received, the input unit 12 reads the MOV file 7. Subsequently, the application execution unit 11 advances the process to step S6.

Meanwhile, in step S4, when a VIB file name is input to the input file name entry field, the application execution unit 11 issues an instruction to read a VIB file (here, VIB file 8) specified by the VIB file name. After this instruction is received, the input unit 12 reads the VIB file 8. Subsequently, the application execution unit 11 advances the process to step S6.

In step S5, the application execution unit 11 issues an instruction for the input unit 12 to read a WAV file (here, WAV file 6) specified by a WAV file name which is input to the input file name entry field. After this instruction is received, the input unit 12 reads the WAV file 6. Subsequently, the application execution unit 11 advances the process to step S6.

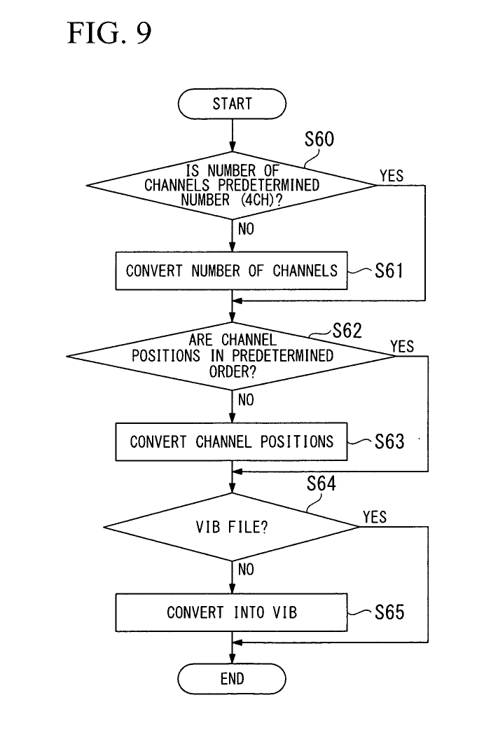

Next, the application execution unit 11 causes the conversion processing unit 13 to execute the file conversion process (step S6). The detailed operation of this file conversion process will be described with reference to FIG. 9.

FIG. 9 is a flow diagram showing an example of an operation of the file conversion process which is performed by the conversion processing unit 13 according to the present embodiment. The file operation unit 131 of the conversion processing unit 13 acquires an input file. Next, the channel number conversion unit 133 of the data operation unit 132 determines whether the number of channels of the input file acquired by the file operation unit 131 is coincident with the number of vibrators included in the vibration generation unit 5 which is indicated by the configuration information stored in the storage unit 136 (step S60).

Here, the number of channels is set in advance in the input file (WAV file 6, MOV file 7, or VIB file 8). For example, the number of channels in a case of a WAV file generated for a stereo sound system including two speakers on the right and left is two. In addition, the number of channels in a case of a WAV file generated for a surround sound system including, for example, four speakers at the front at the left, the front at the right, the front in the center, and the rear is four. In addition, the number of vibrators included in the vibration generation unit 5 is, for example, four as described above.

The channel number conversion unit 133 advances the process to step S61 when it is determined that the number of channels of the input file is two, the number of vibrators is four, and the number of channels of the input file and the number of vibrators included in the vibration generation unit 5 are not coincident with each other (step S60: NO). On the other hand, the channel number conversion unit 133 advances the process to step S62 when it is determined that the number of channels of the input file is four, the number of vibrators is four, and the number of channels of the input file and the number of vibrators included in the vibration generation unit 5 are coincident with each other (step S60: YES).

In step S61, the channel number conversion unit 133 performs a channel number conversion process. Specifically, when the number of channels of the input file is two and the number of vibrators is four, the channel number conversion unit 133 performs a process of expanding the number of channels from two channels to four channels. For example, the channel number conversion unit 133 performs a phase conversion operation on two-channel data of the input file to newly generate two-channel data, and thus expands the number of channels from two channels to four channels. Subsequently, the channel number conversion unit 133 advances the process to step S62.

Meanwhile, here, an example in which the channel number conversion unit 133 performs a process of expanding the number of channels has been described, but there is no limitation thereto. For example, the channel number conversion unit 133 may perform a process of reducing the number of channels. Specifically, when the number of channels of the input file is four and the number of vibrators is two, the channel number conversion unit 133 performs a process of reducing the number of channels from four channels to five channels. In this case, the channel number conversion unit 133 performs an arithmetic operation of adding data of each channel of the input file by every two channels, and thus reduces the number of channels from four channels to two channels.

Next, the channel position conversion unit 134 of the data operation unit 132 determines whether the channel position of each channel of the input file (file after conversion when the conversion of the number of channels is performed in step S61. Hereinafter, the file is described as a file to be determined by the channel position conversion unit 134 in step S62 and step S63) is coincident with the arrangement of the vibrators included in the vibration generation unit 5 which is indicated by the configuration information stored in the storage unit 136 (step S62).

Here, the channel position of each channel is set in advance in the file to be determined by the channel position conversion unit 134. For example, in a case of a WAV file of two channels which is generated for a stereo sound system including two speakers on the right and left, the channel position is configured such that a first channel is located on the left as LEFT, and that a second channel is located on the right as RIGHT. In addition, in a case of a WAV file of four channels which is generated for a surround sound system including, for example, four speakers at the front at the left, the front at the right, the front in the center, and the rear, the channel position is configured such that a first channel is located at the front at the left as FL, a second channel is located at the front at the right as FR, a third channel is located at the front in the center as FC, and that a fourth channel is located at the rear as R. In addition, the arrangement of the vibrators included in the vibration generation unit 5 is configured such that, for example, as described above, the vibrator 51 is located at the front at the left as FL, the vibrator 52 is located at the front at the right as FR, the vibrator 53 is located at the rear at the left as RL, and the vibrator 54 is located at the rear at the right as RR.

As an example, a case will be described in which the file to be determined by the channel position conversion unit 134 is a four-channel WAV file, and is configured such that a first channel is located at the front at the left as FL, a second channel is located at the front at the right as FR, a third channel is located at the front in the center as FC, and a fourth channel is located at the rear as R. In this case, the channel positions of the file to be determined by the channel position conversion unit 134 are the front at the left as FL, the front at the right as FR, the front in the center as FC, and the rear as R, whereas the arrangement of the vibrators is the front at the left as FL, the front at the right as FR, the rear at the left as RL, and the rear at the right as RR. That is, the front in the center FC and the rear R in the channel positions and the rear at the left RL and the rear at the right RR in the arrangement of the vibrators are different from each other. Therefore, in this case, the channel position conversion unit 134 determines that the channel positions of the file to be determined by the channel position conversion unit 134 and the arrangement of the vibrators are not coincident with each other (step S62: NO), and advances the process to step S63.

On the other hand, the channel position conversion unit 134 advances the process to step S64 when it is determined that the channel positions of the file to be determined by the channel position conversion unit 134 and the arrangement of the vibrators are coincident with each other (step S62: YES).

In step S63, the channel position conversion unit 134 performs a channel position conversion process. As described above, when the channel positions of the file to be determined by the channel position conversion unit 134 are the front at the left FL, the front at the right FR, the front in the center FC, and the rear R, while the arrangement of the vibrators is the front at the left FL, the front at the right FR, the rear at the left RL, and the rear at the right RR, the channel position conversion unit 134 performs a process of converting the localization of a vibration with respect to this file, in accordance with the arrangement of the vibrators. Specifically, an arithmetic operation is performed to add data of a third channel (the front in the center FC) in the channel positions of the file to be determined by the channel position conversion unit 134 to data of each channel on the front at the left FL and the front at the right FR. In addition, an arithmetic operation is performed to divide data of a fourth channel (the rear R) in the channel positions of the file to be determined by the channel position conversion unit 134 into data of each channel at the rear at the left RL and the rear at the right RR. Subsequently, the channel position conversion unit 134 advances the process to step S64.

Next, the file format conversion unit 135 of the data operation unit 132 determines whether the input file (when the conversion of the number of channels is performed in step S61, a file after the channel number conversion is to be determined; further, when the conversion of the channel position is performed in step S63, a file after the channel position conversion is to be determined. Hereinafter, the file is described as a file to be determined by the file format conversion unit 135 in step S64 and step S65) is coincident with the format of the output file (step S64). Here, a case will be described in which the VIB generation function is selected by a user, that is, the format of the output file is a VIB file.

When it is determined that the file to be determined by the file format conversion unit 135 is a VIB file (step S64: YES), the file format conversion unit 135 outputs the file to the output unit 16 as the VIB file 10, and terminates the process. On the other hand, when it is determined that the file to be determined by the file format conversion unit 135 is not a VIB file (step S64: NO), the file format conversion unit 135 advances the process to step S65.

In step S65, the file format conversion unit 135 converts the file to be determined by the file format conversion unit 135 into a VIB file, outputs the converted VIB file to the output unit 16 as the VIB file 10, and terminates the process.

Meanwhile, when the MOV generation function is selected by a user, that is, when the format of the output file is a MOV file, the file format conversion unit 135 determines whether the file to be determined by the file format conversion unit 135 is a MOV file in step S64 mentioned above. In addition, when the format of the output file is a MOV file, and it is determined that the file to be determined by the file format conversion unit 135 is a MOV file, the file format conversion unit 135 outputs the file to the output unit 16 as the MOV file 9, and terminates the process. In addition, when the format of the output file is a MOV file, the file format conversion unit 135 converts the file to be determined by the file format conversion unit 135 into a MOV file in step S65 mentioned above, outputs the converted MOV file to the output unit 16 as the MOV file 9, and terminates the process.

Thereby, the VIB file 10 or the MOV file 9 which is appropriate for the configuration of the vibration generation unit 5 is generated by the conversion processing unit 13.

Next, reference will be made to FIG. 11 to describe an operation of reproducing a multimedia container (MOV file) having vibration data written in a user area.

FIG. 11 is a flow diagram showing an example of an operation in which the data processing device 1 according to the present embodiment reproduces a multimedia container file (MOV file) in which vibration data is written in a user area.

First, when a user operates the operation unit 2 and performs an operation of reproducing the MOV file 9 including vibration data, the application execution unit 11 instructs the input unit 12 to read the MOV file. After this instruction is received, the input unit 12 reads the MOV file 9 including the vibration data of which reproduction performance is instructed (step S11). The application execution unit 11 then instructs the conversion processing unit 13, the audio processing unit 14 and the image processing unit 15 to execute a reproduction process. After this instruction is received, the image processing unit 15 extracts image data in data of the MOV file 9 which is input in the input unit 12, converts the data format into a format which is displayed by the display unit 3, and outputs the data to the display unit 3 through the output unit 16, to thereby reproduce an image (step S12).

In synchronization with this image reproduction, the audio processing unit 14 extracts audio data in the data of the MOV file 9 which is input in the input unit 12. The audio processing unit 14 converts a format of the extracted data into a format capable of being output from the audio output unit 4, and outputs the data to the audio output unit 4 through the output unit 16, to thereby reproduce audio in synchronization with the image reproduction (step S13).

Further, in synchronization with the image reproduction, the data operation unit 132 of the conversion processing unit 13 extracts vibration data in the data of the MOV file 9 which is input in the input unit 12. The data operation unit then converts a format of the extracted data into a format capable of generating a vibration in the vibration generation unit 5, and outputs the data to the vibration generation unit 5 through the output unit 16, to thereby generate a vibration in synchronization with the image reproduction (step S 14). The vibration data controls the localization of a vibration or the movement of a vibration source, in accordance with the image reproduction. For example, the localization of a vibration or the position of a vibration source is controlled by adjusting the vibration data in accordance with the movement of an object in an image. Thereby, when an automobile is displayed in an image, by controlling the position of a vibration source and the amount of movement in accordance with the movement of the automobile in the image, it is possible to create a scene as if a user is present in that place.

Next, the application execution unit 11 determines whether the MOV file 9 has been read out to the end (step S15). The application execution unit 11 reads out the next data when the file has not been read out to the end, and repeats a process of reproducing an image, audio and a vibration in synchronization with each other. On the other hand, when the MOV file 9 has been read out to the end, the process is terminated.

In this manner, since an image, audio and a vibration can be reproduced in synchronization with each other, it is possible to obtain a performance effect caused by a vibration, in addition to an image and audio. In addition, a user can feel more reality than ever before with respect to an image and audio, through such a performance effect.

Meanwhile, in the above-mentioned description, an example in which a MOV file is used has been given as an example of the multimedia container file, but the multimedia container file to which vibration data is added is not limited to the MOV file, and may be other existing multimedia container files. That is, when a user area can be provided and vibration data can be written in this user area, any multimedia container file may be used.

In addition, here, a case in which the application execution unit 11 reproduces the MOV file 9 has been described by way of example, but the application execution unit 11 may reproduce the VIB file 10. In this manner also, the application execution unit 11 can control the localization of a vibration or the position of a vibration source.

As described above, the conversion processing unit 13 included in the data processing device 1 according to the present embodiment converts first vibration data into the MOV file 9 or the VIB file 10 (second vibration data) configured to control the localization of a vibration through the vibration state of the vibration generation unit 5, on the basis of the configuration information indicating the configuration of the vibration generation unit 5 (vibration unit), and the WAV file 6, the MOV file 7, or the VIB file 8 (first vibration data) which is input. Thereby, the data processing device 1 can generate the MOV file 9 or the VIB file 10 which is appropriate for the configuration of the vibration generation unit 5. That is, the data processing device 1 can expand the type of a multichannel system to be output.

In addition, the conversion processing unit 13 converts the input file (first vibration data) into the output file (second vibration data) on the basis of the number of channels of the WAV file 6, the MOV file 7, or the VIB file 8 (first vibration data) which is input, and information indicating the number of vibration elements included in the vibration generation unit 5. Thereby, the conversion processing unit 13 can generate an output file having the number of channels according to the number of vibration elements.

In addition, when the number of vibration elements included in the vibration generation unit 5 and the number of channels of the WAV file 6, the MOV file 7, or the VIB file 8 (first vibration data) which is input are different from each other, the conversion processing unit 13 converts the number of channels of the input file (first vibration data) in accordance with the number of vibration elements included in the vibration generation unit 5. Thereby, the conversion processing unit 13 can generate an output file having the number of channels according to the number of vibration elements. Therefore, compared to a case where the conversion processing unit 13 is not included, it is possible to further improve a sensation of localization of a vibration and a sensation of movement which are felt by a user.

In addition, the conversion processing unit 13 converts the input file (first vibration data) into the output file (second vibration data), on the basis of information indicating the positions of the vibration elements included in the vibration generation unit 5, and localization information indicating the localization of each channel of the WAV file 6, the MOV file 7, or the VIB file 8 (first vibration data) which is input. Thereby, the conversion processing unit 13 can generate an output file having the localization information of a vibration according to the arrangement of the vibration elements.

In addition, when the positions of the vibration elements included in the vibration generation unit 5 and the localization of each channel of the WAV file 6, the MOV file 7, or the VIB file 8 (first vibration data), indicated by the localization information, which is input are different from each other, the conversion processing unit 13 converts the localization of each channel of the input file in accordance with the positions of the vibration elements. Thereby, the conversion processing unit 13 can generate an output file having the localization information of a vibration according to the arrangement of the vibration elements. Therefore, compared to a case where the conversion processing unit 13 is not included, it is possible to further improve a sensation of localization of a vibration and a sensation of movement which are felt by a user.

Meanwhile, in the present embodiment, an example where a WAV file is used as a file having audio data recorded therein has been described, but the file having audio data recorded therein is not limited to a WAV file. For example, a file having other existing audio data recorded therein may be used.

Meanwhile, a configuration in which the data processing device 1 includes the application execution unit 11 and the conversion processing unit 13, and the application execution unit 11 supplies the MOV file 9 or the VIB file 10, converted (generated) by the conversion processing unit 13, to the vibration generation unit 5 to thereby generate a vibration has been described by way of example, but there is no limitation thereto. For example, the application execution unit 11 and the conversion processing unit 13 may be included in devices different from each other. That is, a first data processing device may be configured to include at least the conversion processing unit 13, and a second data processing device may be configured to include at least the application execution unit 11 and the vibration generation unit 5. In this case, the second data processing device is an application device. With such a configuration, it is also possible to exhibit the above-mentioned effect by supplying the MOV file 9 or the VIB file 10, converted (generated) by the conversion processing unit 13 of the first data processing device, to the application execution unit 11 of the second data processing device. With such a configuration, it is possible to reduce the sizes of both the first data processing device and the second data processing device.

Meanwhile, a program for realizing the function of the processing unit in FIG. 1 may be recorded in a computer readable recording medium, and thus a file manipulation process and a data manipulation process may be performed by causing a computer system to read and execute the program recorded in this recording medium. Meanwhile, the term “computer system” as used herein is assumed to include an OS or hardware such as peripheral devices. In addition, the “computer system” is also assumed to include a WWW system provided with a website providing environment (or a display environment). In addition, the term “computer readable recording medium” refers to a flexible disk, a magneto-optic disc, a ROM, a portable medium such as a CD-ROM, and a storage device such as a hard disk built into the computer system. Further, the “computer readable recording medium” is also assumed to include media that hold a program for a certain period of time like a volatile memory (RAM) inside a computer system serving as a server or a client when the program is transmitted through networks such as the Internet or communication lines such as a telephone line.

In addition, the above program may be transmitted from a computer system having the program stored in a storage device or the like through a transmission medium or through transmitted waves in the transmission medium to other computer systems. Here, the “transmission medium” that transmits a program refers to a medium having a function of transmitting information like networks (communication networks) such as the Internet or communication channels (communication lines) such as a telephone line. In addition, the above-mentioned program may realize a portion of the above-mentioned functions. Further, the above-mentioned program may be a so-called difference file (difference program) capable of realizing the above-mentioned functions by a combination with a program which is already recorded in a computer.

As stated above, the embodiment of the present invention has been described in detail with the accompanying drawings, but specific configurations are not limited to the above embodiment, and also include a design and the like without departing from the scope of the present invention.

1. A data processing device comprising:
a conversion processing unit configured to convert first vibration data into second vibration data configured to control localization of a vibration through a vibration state of a vibration unit included in an application device, on the basis of configuration information indicating a configuration of the vibration unit and the first vibration data which is input.

2. The data processing device according to claim 1, wherein the configuration information includes information indicating the number of vibration units included in the application device,
the first vibration data is data which is constituted by one or a plurality of channels, and
the conversion processing unit further converts the first vibration data into the second vibration data on the basis of the number of channels of the first vibration data and information indicating the number of vibration units included in the application device.

3. The data processing device according to claim 2, wherein when the number of vibration units included in the application device and the number of channels of the first vibration data are different from each other, the conversion processing unit converts the first vibration data into the second vibration data by converting the number of channels of the first vibration data in accordance with the number of vibration units included in the application device.

4. The data processing device according to claim 1, wherein the configuration information includes information indicating a position of the vibration unit within the application device,
the first vibration data is data which is constituted by one or a plurality of channels, and
the conversion processing unit further converts the first vibration data into the second vibration data on the basis of the information indicating the position of the vibration unit within the application device and localization information indicating localization of each channel of the first vibration data.

5. The data processing device according to claim 4, wherein when the position of the vibration unit included in the application device and localization of each channel of the first vibration data which is indicated by the localization information are different from each other, the conversion processing unit converts the first vibration data into the second vibration data by converting the localization of each channel of the first vibration data in accordance with the position of the vibration unit.

6. A data processing program configured to cause a computer to execute a conversion process step of converting first vibration data into second vibration data configured to control localization of a vibration through a vibration state of a vibration unit included in an application device, on the basis of configuration information indicating a configuration of the vibration unit and the first vibration data which is input.
